(19) United States
(12) Patent Application Publication
(10) Pub. No.: US 2005/0088463 A1
(43) Pub. Date: Apr. 28, 2005

(54) Expanded display for cell phone, palm pilot or computer

(76) Inventor: Donald L. Schilling, Palm Beach Gardens, FL (US)

Correspondence Address: David Newman ChrtD., P O Box 956, INDIAN HEAD, MD, 20640, US

(21) Appl. No.: 10/690,963

(22) Filed: Oct. 23, 2003

(51) Int. Cl. G09G 5/00; G09G 5/02

(52) U.S. Cl. 345/699

(57) ABSTRACT

An improvement to a transceiver, such as a cell phone, a palm pilot, or equivalent telephone or computer display device, comprising a plurality of display devices, expanding supports, and a screen-size indicator. The expanding supports are connected to the transceiver, such as a cell phone, palm pilot or computer, and to the plurality of display devices. The expanding supports expands the plurality of display devices about the transceiver, such as a cell phone. The screen-size indicator is connected to the plurality of display devices. The screen-size indicator displays the video signal on the transceiver, such as a cell phone display, or the plurality of display devices, or the combination of the transceiver, such as a cell phone, palm pilot or computer, display and the plurality of display devices, as determined by the screen size, respectively.

### BACKGROUND OF THE INVENTION

The present invention relates to displays for a cell phone, and more particularly to a large viewing screen on a small cell phone.

### DESCRIPTION OF THE RELEVANT ART

Current cell phones, palm pilots and laptop computers have limited display capability, usually consisting of a single liquid crystal display (LCD) device. The small size limits functionality for displaying movies and high definition television signals.

### SUMMARY OF THE INVENTION

A general object of the invention is to provide a large display screen on a small cell phone, palm pilot, or computer.

Another object of the invention is to permit the viewing of the total picture on any part of the screen that is expanded.

According to the present invention, as embodied and broadly described herein, an improvement to a transceiver, such as a cell phone, palm pilot, or equivalent telephone or computer, which uses an LCD device, plasma device, or any other screen is provided, comprising a plurality of display devices, expanding means, and a screen-size indicator. The expanding means is connected to the transceiver, such as a cell phone or computer and to the plurality of display devices. The expanding means expands the plurality of display devices about the transceiver, such as a cell phone, palm pilot or computer.

The screen-size indicator electrically is connected to the plurality of display devices. The screen-size indicator determines a screen size. In response to the screen size and responsive to a video signal, the screen-size indicator displays the video signal on the transceiver, such as a cell phone, palm pilot or computer, displays, or the plurality of display devices, or the combination of the plurality of display devices, as determined by the screen size, respectively.

Additional objects and advantages of the invention are set forth in part in the description which follows, and in part are obvious from the description, or may be learned by practice of the invention. The objects and advantages of the invention also may be realized and attained by means of the instrumentalities and combinations particularly pointed out in the appended claims.

### BRIEF DESCRIPTION OF THE DRAWINGS

The accompanying drawings, which are incorporated in and constitute a part of the specification, illustrate preferred embodiments of the invention, and together with the description serve to explain the principles of the invention.

FIG. 1 shows an expanded view of a three section screen with double width;

FIG. 2 shows a three section screen with double height;

FIG. 3 shows a three section screen, partially expanded;

FIG. 4 shows display ejecting from a side of a transceiver, such as a cell phone, palm pilot or computer; and

FIG. 5 is a system block diagram.

### DETAILED DESCRIPTION OF THE PREFERRED EMBODIMENTS

Reference now is made in detail to the present preferred embodiments of the invention, examples of which are illustrated in the accompanying drawings, wherein like reference numerals indicate like elements throughout the several views.

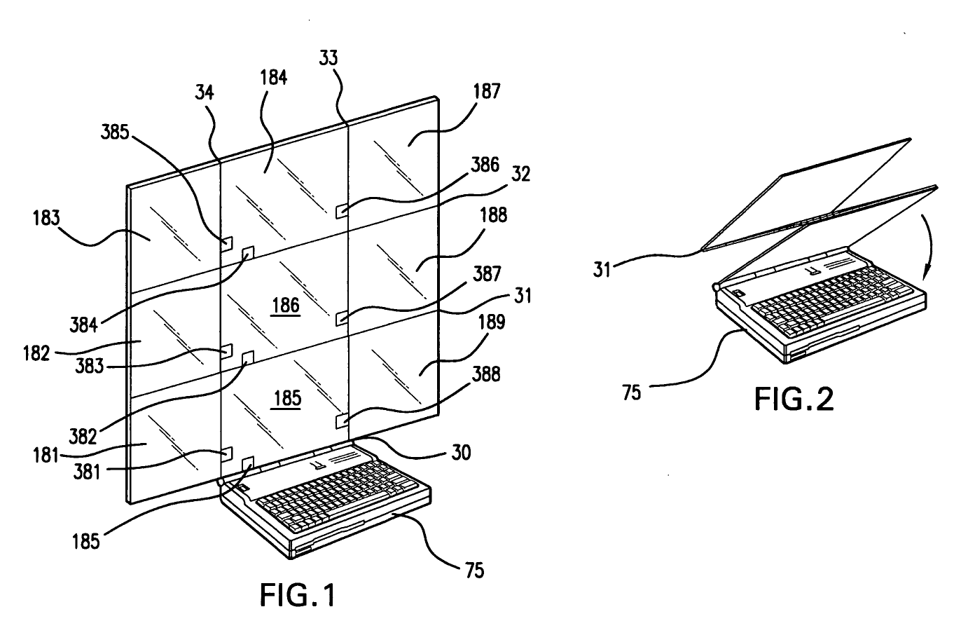

The present invention provides a novel improvement to a transceiver, such as a cell phone, palm pilot or computer-type device, which use a liquid crystal display (LCD) device, or plasma device or equivalent panel display device. As illustratively shown in FIGS. 1-4, the improvement includes a plurality of display devices, expanding means, and a screen-size indicator. The expanding means is connected to the transceiver 75, such as a cell phone, palm pilot, or computer, and to the plurality of display devices. The expanding means expands the plurality of display devices about the transceiver 75. Each of the display devices may be embodied as an LDC device, plasma device, or equivalent panel display device, or a combination of LCD devices, plasma devices or equivalent panel display devices.

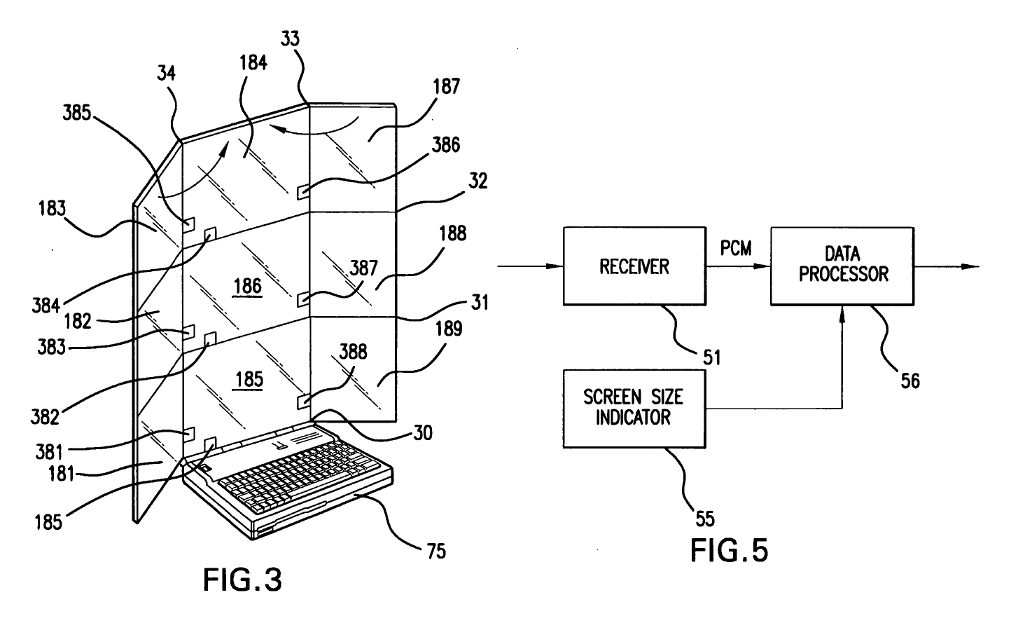

The expanding means, as illustratively shown in FIGS. 1-3, may be embodied as expanding the plurality of display devices from the transceiver 75, by unfolding about the transceiver 75. A large viewing screen, using the plurality of display devices, can expand a display on a small transceiver 75, such as a cell phone, palm pilot or computer, such as a laptop. In the FIG. 1, the display screen is expanded vertically by a factor of three, and horizontally by a factor of two. FIG. 1 shows expanding a screen with the plurality of display devices 181, 182, 183, 184, 185, 186, 187, 188, 189 by a plurality of hinges 30, 31, 32, 33, 34, or equivalent pivotal connectors. The plurality of hinges 30, 31, 32, 33, 34, or equivalent pivotal connectors is connected to the plurality of display devices 181, 182, 183, 184, 185, 186, 187, 188, 189, and to the transceiver 75, such as a cell phone, palm pilot or computer. FIG. 2 shows a screen being expanded vertically, by a factor of three, with a plurality of display devices. FIG. 3 shows the screen of FIG. 1, with the side screens not fully expanded. The hinges 30, 31, 32, 33, 34, or equivalent pivotal connectors between appropriate display devices 181, 182, 183, 184, 185, 186, 187, 189 allow the screen to not be fully expanded, as shown. Other dimensions, sizes, for expanding the screen also are possible.

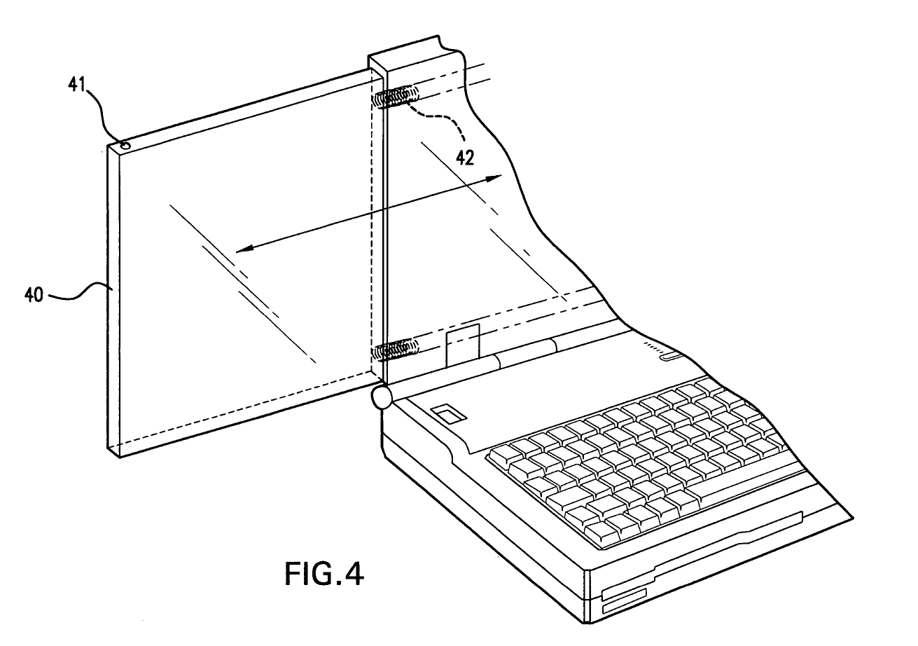

Alternatively, as shown in FIG. 4, the expanding means may be embodied as ejecting the plurality of display devices, such as panels of LCD devices or plasma screens or equivalent display panels, from the side of the transceiver 75. FIG. 4 shows a latch 41, embodied as a button or lever, for controlling the ejection of the additional display device 40. A spring 42 may be used to eject the display device 40, once the latch 41, button or level permits ejection, by releasing the display device 40. Equivalently, the device for controlling the ejection may be similar to that used for CD drives, currently available on laptop computers. The CD drives are well-known in the art for pressure sensitive release, with a spring type load for ejecting the CD drive.

As illustratively shown in FIG. 5, a screen-size indicator 55 electrically is connected to the plurality of display devices. The screen-size indicator 55 is an electrical circuit, preferably a digital circuit or firmware in a gate array circuit or equivalent. A plurality of electrical sensors 381, 382, 383, 384, 385, 386, 387, 388, or equivalent switches or detectors, at each hinge or equivalent pivotal connector for the plurality of display devices of FIGS. 1, 2 and 3, or equivalently an electrical sensor, switch or detector working cooperatively with ejecting the display device of FIG. 4, preferably can be used with a digital circuit to generate a screen-size signal. The plurality of electrical sensors does not require having a sensor at every panel, as shown in FIGS. 1 and 3. The plurality of electrical sensors may be a subset of those shown in FIGS. 1 and 3. Only one sensor on each horizontal hinge and each vertical hinge, by way of example, may be sufficient for detecting the size of the plurality of display devices. Other topologies of the plurality of electrical sensors may be used, depending on engineering design or engineering specifications of a particular application.

Alternatively, electrical circuits which detect the number of pixels available from an expanded screen, of the plurality of display devices, can generate the screen-size signal. In its simplest from, the screen-size signal indicates when the screen is expanded or not expanded, and the relative size of the expanded screen.

The screen-size indicator 55 determines a screen size. In response to the screen-size signal and responsive to a video signal from a receiver 51 of the transceiver 75, such as a cell phone, palm pilot or computer, the screen-size indicator 55 displays the video signal on the transceiver 75, such as a cell phone, palm pilot or computer, display, or the plurality of display devices, or the combination of the plurality of display devices, as determined by the screen-size signal, respectively. The plurality of sensors 381, 382, 383, 384, 385, 386, 387, 388, shown in FIG. 1, is one approach for determining how many display devices are expanded. Thus, the present invention may allow for expanding the screen with only a limited number of display devices, and not all of the available of the plurality of display devices.

An additional purpose of this invention is to permit the viewing of the total picture on any part of the screen that is expanded. Thus, the screen may be fully expanded, in which case the picture is six times the screen area that would occur if only the first screen were used. This is useful, since in some locations there is less room than others, for example, a subway during rush hour versus a restaurant in the afternoon, or your living room.

To present the total picture, refer to the improvement to the receiver 51, as shown in FIG. 5. FIG. 5 shows only those features that are germane to this invention. Thus, there is a 3^{rd} Generation(3G) Cellular Standard, receiver 51, which, as is well-known in the art, is used to receive and transform the data or video signal, the “content”, into a pulse-code-modulation (PCM) signal. In the future, other standards may be employed, but the screen extension system still will be applicable. The screen-size indicator 55 receives a signal from the switches of FIG. 1, which indicate whether a panel has been fully expanded for viewing. If the screen were expanded, then the content will be displayed to the display devices in the plurality of display devices. The screen-size indicator 55 tells the data processor 56 the number of pixels per line and the number of lines per frame. The data processor 56 is well-known in the art as used with available cell phones, palm pilots and computers.

Two options are available: (1) All content received by receiver 51 can be displayed on smallest screen size, i.e., one display device, or a subset of the plurality of display devices. In this case, as the screen is expanded, no extra information is available. There are extra pixel elements available, however, if the screen were digital. In this case, the additional PCM signals needed, are generated using standard interpolation techniques, which are well-known in the art. (2) All content received by receiver 51 can be displayed on the largest screen, with all of the display devices of the plurality of display devices expanded. In this case, as the screen size is decreased, information is lost. The use of a smaller screen is like reducing the number of pixels/line and also the number of lines per frame, while keeping the line rate and the frame rate fixed. While a possible solution is to use every second or third PCM word, a higher quality solution is to PCM digital-to-analog (D/A) convert, filter, and then PCM encode for the new size screen.

The main screen can be expanded using a clip that one pushes to slide the expanding portion. Or, the screen can be expanded by pushing a button, illustrated by the blue button, that releases a spring, which pushes out the screen. The expanded screen can house additional, or more, screens that can be released in the same or other ways.

The technique used to expand the screen may be those shown, or those which are equivalent to those shown. The mechanical procedure of expansion may vary from those illustrated. The screen, however, is expandable on the sides and top, to suit the user's needs.

The screen size indicator 55 is told the screen size and notifies the necessary electronics to adjust the number of lines per frame, and pixels per line.

The user determines the screen size, one suitable to the users immediate environment. When the screen size is attained, the screen size indicator notifies the electronics.

It will be apparent to those skilled in the art that various modifications can be made to the expanded display for transceiver, such as a cell phone of the instant invention without departing from the scope or spirit of the invention, and it is intended that the present invention cover modifications and variations of the expanded display for transceiver, provided they come within the scope of the appended claims and their equivalents.

1. An improvement to a transceiver, such as a cell phone, palm pilot or computer, comprising:
a plurality of display devices;
expanding means, connected to said transceiver and to the plurality of display devices, for expanding the plurality of display devices about said transceiver; and
screen-size indicator, electrically connected to the plurality of display devices, for determining a screen size, said screen-size indicator, responsive to the screen size and responsive to a video signal, for displaying the video signal on the plurality of display devices, or the combination of the plurality of display devices, as determined by the screen size, respectively.

2. The improvement as set forth in claim 1, with the expanding means including a spring and a latch, for ejecting and securing a display device of the plurality of display devices.

3. The improvement as set forth in claim 1 with the expanding means including hinges for expanding the plurality of display devices.

4. The improvement as set forth in claim 1, further including a plurality of sensors connected to the plurality of display devices, respectively, for sensing when the plurality of display devices are expanded.

5. The improvement as set forth in claim 1, with the expanding means including means for folding the plurality of display devices.

6. A method for improving a transceiver, such as a cell phone, palm pilot or computer, with a plurality of display devices connected to said transceiver, comprising the steps of:
expanding the plurality of display devices about said transceiver; and
determining a screen size;
displaying, responsive to the screen size and responsive to a video signal, the video signal on the plurality of display devices, or the combination of the plurality of display devices, as determined by the screen size, respectively.

7. The improvement as set forth in claim 6, with the step of expanding including the step of ejecting, using a spring and a latch, a display device of the plurality of display devices.

8. The improvement as set forth in claim 6, with the step of expanding including the step of expanding with hinges for the plurality of display devices.

9. The improvement as set forth in claim 6, further including the step of sensing, with a plurality of sensors connected to the plurality of display devices, respectively, when the plurality of display devices are expanded.

10. The improvement as set forth in claim 6, with the step of expanding including the step of folding the plurality of display devices.

11. An improvement to a transceiver, such as a cell phone, palm pilot or computer, comprising:
a plurality of display devices;
a plurality of hinges, connected to said transceiver and to the plurality of display devices, for expanding the plurality of display devices about said transceiver; and
screen-size indicator, electrically connected to the plurality of display devices, for determining a screen size, said screen-size indicator, responsive to the screen size and responsive to a video signal, for displaying the video signal on the plurality of display devices, or a combination of the plurality of display devices, as determined by the screen size, respectively.

12. The improvement as set forth in claim 11, further including a plurality of switches connected to the plurality of display devices, respectively, for sensing when the plurality of display devices are expanded.
